(19) United States
(12) Patent Application Publication
(10) Pub. No.: US 2023/0058636 A1
(43) Pub. Date: Feb. 23, 2023

(54) METHOD AND DEVICE FOR PREDICTING SAFETY RISK LEVEL SECTION OF FOOD

(71) Applicant: Hubei Provincial Institute for Food Supervision And Test, Hubei (CN)

(72) Inventors: Hong WEN, Hubei (CN); Jia YIN, Hubei (CN); Pengcheng GUO, Hubei (CN); Man DONG, Hubei (CN); Xiang CHEN, Hubei (CN); Li CHEN, Hubei (CN); Ning XU, Hubei (CN)

(73) Assignee: Hubei Provincial Institute for Food Supervision And Test, Hubei (CN)

(21) Appl. No.: 17/562,848

(22) Filed: Dec. 27, 2021

Related U.S. Application Data
(63) Continuation of application No. PCT/CN2021/117694, filed on Sep. 10, 2021.

(30) Foreign Application Priority Data
Aug. 11, 2021 (CN) 202110919801.8

(51) Int. Cl. G06Q 50/26; G06N 5/02

(52) U.S. Cl. CPC G06Q 50/265; G06N 5/02

(57) ABSTRACT

A method and a device for predicting food safety risk level section are provided in the present application. The method includes: obtaining risk level time series data of the food; decomposing the risk level time series data to obtain a plurality of sub-series data; performing point predictions on the plurality of sub-series data to obtain corresponding point prediction results; determining a final point prediction result corresponding to the food risk level time series data based on the point prediction results corresponding to the plurality of sub-series data; determining a prediction residual corresponding to the final point prediction result; and determining a section prediction result by performing section prediction based on the prediction residua. In the present application, more prediction information and quantitative prediction of the uncertainty of future food risks are provided by adding section prediction based on point prediction.

### CROSS-REFERENCE TO RELATED APPLICATIONS

This application is a continuation of International Patent Application Number PCT/CN2021/117694 filed Sep. 10, 2021, which claims priority to Chinese Patent Application Number CN 202110919801.8 filed Aug. 11, 2021, the contents of which are incorporated herein by reference in its entirety.

### TECHNICAL FIELD

The present application relates to the technical field of food safety, and in particular to a method and a device for predicting a safety risk level section of food.

### BACKGROUND

Food safety is an important issue worldwide, and its impact can involve all aspects of social life, relating to people's health, economic development, and social stability. However, there are still a great number of food safety incidents, many of which are caused by inadequate prevention. Therefore, it is of great social significance to conduct research on prediction of food safety.

Most of the current predictions on food safety are deterministic, and the methods used can be divided into two categories depending on principles, namely statistics-based methods and machine learning-based methods. The statistics-based methods are mostly premised on the trend of linear changes, while the machine learning-based methods, especially neural network methods, are more suitable for mining non-linear changes. The statistics-based methods are mainly represented by an ARIMA model family and a GARCH model family, while machine learning-based and neural network-based models are represented by SVM and LSTM. However, both types of models can only give deterministic prediction results without providing information about uncertainty. For a decision maker, it is often preferable to know the fluctuation range of results while knowing the deterministic prediction results, so that the decision is more controllable.

### SUMMARY

According to the present application, a method and a device for predicting a safety risk level section of food are provided, so as to overcome the shortcomings of less information provided by prediction methods in the prior art, and provide more information and quantitatively predict uncertainty by providing section predictions.

According to a first aspect of the present application, a method for predicting a safety risk level section of food is provided, including:

obtaining risk level time series data of the food;

decomposing the risk level time series data to obtain a plurality of sub-series data;

performing point predictions on the plurality of sub-series data to obtain corresponding point prediction results;

determining a final point prediction result corresponding to the risk level time series data based on the point prediction results corresponding to the plurality of sub-series data;

determining a prediction residual corresponding to the final point prediction result; and

determining a section prediction result by performing section prediction based on the prediction residual.

According to the method of the present application, the determining the prediction residual corresponding to the final point prediction result specifically includes:

determining a first time point corresponding to the final point prediction result;

obtaining a plurality of time points prior to the first time point, where time intervals between every two adjacent time points of the multiple time points is the same, and a first time interval between a time point closest to the first time point and the first time point is equal to the time interval;

determining a prediction residual at each of the plurality of time points; and

determining a prediction residual at the first time point based on the prediction residuals at the plurality of time points as the prediction residual corresponding to the final point prediction result.

According to the method of the present application, the obtaining risk level time series data of the food specifically includes:

obtaining test items of time series of the food and test results corresponding to the test items;

performing numerical processing on non-numerical results among the test results to obtain values of the non-numerical results;

determining a risk level of each sample of the food based on numerical results and the values of the non-numerical results among the test results;

determining a risk level of the food corresponding a time period based on the risk level of each sample of the food detected during the time period; and

obtaining the risk level time series data of the food based on the risk level of the food corresponding to each time period among respective time periods.

According to the method of the present application, the decomposing the risk level time series data specifically includes:

decomposing the risk level time series data by wavelet packet decomposition.

According to the method of the present application, the determining the final point prediction result corresponding to the risk level time series data based on the point prediction results corresponding to the plurality of sub-series data specifically includes:

summing the point prediction results corresponding to the plurality of sub-series data to obtain a sum as the final point prediction result corresponding to the risk level time series data.

According to the method of the present application, the determining the prediction residual at each of the plurality of time points specifically includes:

determining a second point prediction result at each of the plurality of time points;

obtaining a risk level actual value at each of the plurality of time points; and

determining a prediction residual at each of the plurality of time points based on the second point prediction result and the risk level actual value.

According to the method of the present application, the missing risk level in one or more time periods is complemented by an interpolation method when there is a missing risk level in one or more time periods of the respective time periods.

According to a second aspect of the present application, a device for predicting a safety risk level section of food is provided, including:

a first processor configured to obtain risk level time series data of the food;

a second processor configured to decompose the risk level time series data to obtain a plurality of sub-series data;

a third processor configured to perform point predictions on the plurality of sub-series data to obtain corresponding point prediction results;

a fourth processor configured to determine a final point prediction result corresponding to the risk level time series data based on the point prediction results corresponding to the plurality of sub-series data;

a fifth processor configured to determine a prediction residual corresponding to the final point prediction result; and

a sixth processor configured to determine section prediction result by performing section prediction based on the prediction residual.

According to a third aspect of the present application, an electronic device is further provided, including a memory, a processor, and computer programs stored on the memory and executable on the processor, when the computer programs are executed by the processor, the processor implements steps of the any method above.

According to a fourth aspect of the present application, a computer-readable storage medium is further provided, having stored thereon computer programs that are executed by a processor to implement steps of any method above.

According to the method and device for a safety risk level section of food according to the present application, future risk for food can be accurately predicted by: obtaining risk level time series data of the food; decomposing the risk level time series data to obtain a plurality of sub-series data; performing point predictions on the plurality of decomposed sub-series data to obtain a point prediction result of each sub-series; determining a final point prediction result corresponding to the entire risk level time series data based on the point prediction result corresponding to each sub-series data. More information can be provided for food safety prediction and the uncertainty of the prediction can be quantified by determining a prediction residual corresponding to the entire risk level time series data, and performing section prediction according to the prediction residual.

### BRIEF DESCRIPTION OF THE DRAWINGS

In order to more clearly illustrate technical solutions in the present application or the prior art, the drawings needed to be used in the descriptions of the embodiments or the prior art will be briefly introduced below. The drawings in the following description only show some embodiments of the present application, and other drawings can be obtained according to the drawings by those skilled in the art without any creative work.

FIG. 1 is a first flow diagram of a method for predicting safety risk level section of a food according to the present application;

FIG. 2 is a second flow diagram of a method for predicting safety risk level section of a food according to the present application;

FIG. 3 is a frame diagram of a wavelet packet decomposition according to the present application;

FIG. 4 is a time-domain diagram showing a wavelet packet decomposition of risk level time series data according to the present application;

FIG. 5 is a schematic diagram showing construction of a time period integrated level and a sample integrated level according to the present application;

FIG. 6 is a structural diagram of a device for predicting safety risk level section of a food according to the present application; and

FIG. 7 is a structural diagram of an electronic device according to the present application.

### DETAILED DESCRIPTION

In order to make the objectives, technical solutions and advantages of the present application clearer, the technical solutions in the present application will be described clearly and completely in conjunction with the accompanying drawings in the present application. The described embodiments are part of the embodiments of the present application, rather than all of the embodiments. All other embodiments obtained by a person of ordinary skill in the art based on the embodiments of the present application without any creative work belong to the protection scope of the present application.

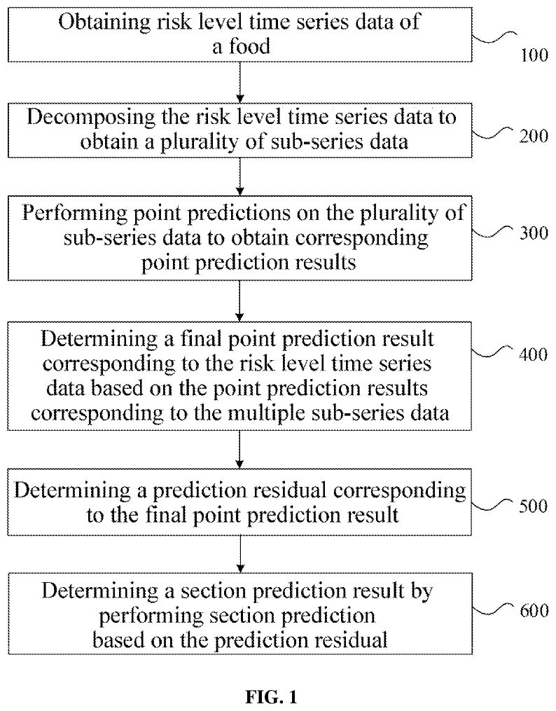

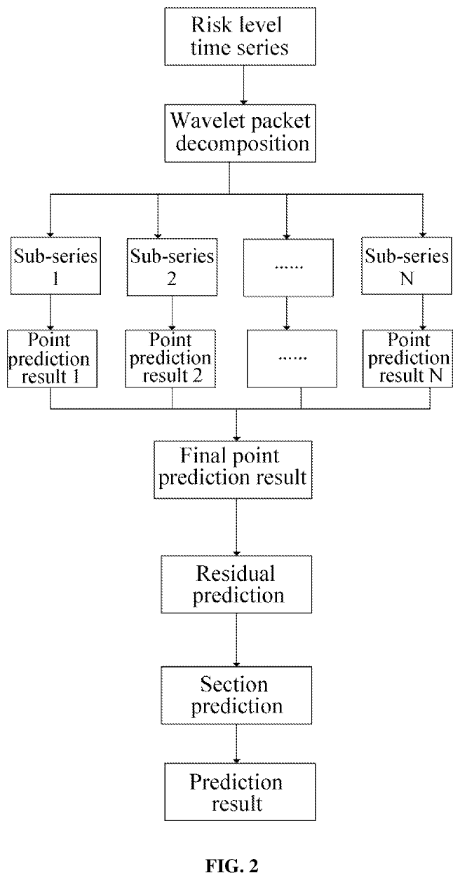

A method for predicting safety risk level section of a food according to the present application is described as follows in conjunction with FIGS. 1 and 2, including the following step 100 to step 600:

Step 100, obtaining risk level time series data of a food whose risk level is to be predicted.

Specifically, the food risk level refers to the level for classifying test results of the food in each time period.

The level classification can be carried out by expert scoring. Specifically, in the present application, the risk level may be classified into multiple levels. Taking 5 levels as an example, the lower test levels 1-2 can be considered as a relatively safe condition, level 3 refers to that it needs to be paid attention, while levels 4-5 are high-risk levels which means early warning and preventive measures are required. However, the present application does not limit the specific number of levels. In addition, the food risk levels in the present application are arranged in a time series manner.

Step 200, decomposing the risk level time series data to obtain multiple sub-series data.

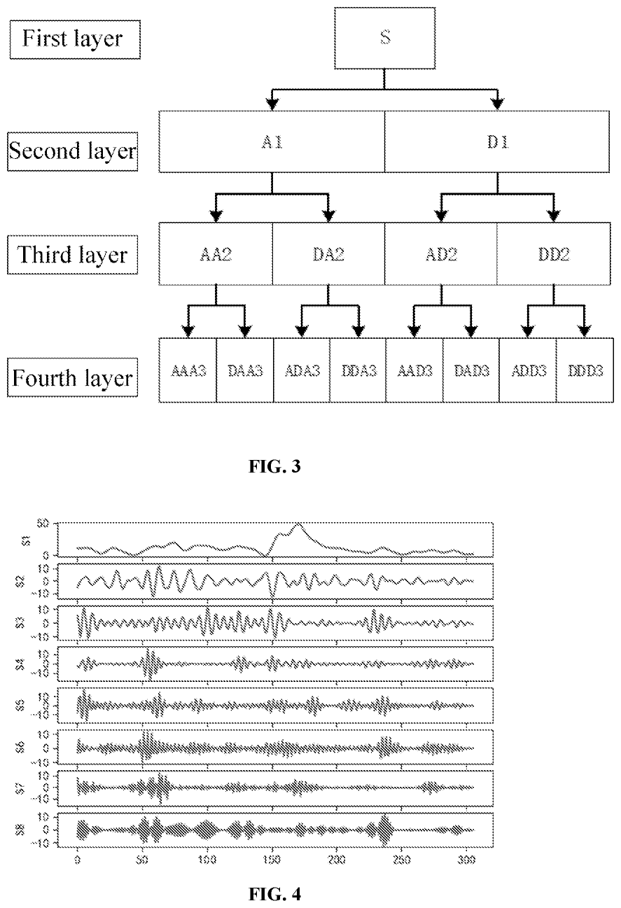

Specifically, referring to FIG. 3, the food risk level time series data is decomposed, for example, using wavelet packet decomposition which is a derivative of wavelet decomposition. Wavelet decomposition will only be used to decompose low-frequency signals recursively instead of decomposing high-frequency signals, while the wavelet packet decomposition is used to decompose both low-frequency and high-frequency information recursively. Therefore, wavelet packet decomposition is competent to classify the original signal in more detail, and is superior to the wavelet decomposition especially for processing high-frequency signals. Referring to FIG. 4, the multiple sub-series data can be obtained using wavelet packet decomposition.

Step 300, performing point predictions on the multiple sub-series data to obtain corresponding point prediction results;

Specifically, statistics-based methods and machine learning-based methods are adopted in the present application. Most of the statistics-based methods are premised on trend of linear changes, while the machine learning-based methods, especially neural network methods, are more suitable for mining non-linear changes. The statistics-based methods are mainly represented by an ARIMA model family and a GARCH model family, while machine learning-based and neural network-based models are represented by SVM and LSTM. In the present application, the ARIMA model is preferably selected for point prediction. The ARIMA model, known as autoregressive integrated moving average model, is a time prediction method developed by Box and Jenkins in the early 1970s. The simplest mathematical expression of ARIMA(1,0,1) is as follows:

Xₜ=ϕ₀+ϕ₁Xₜ₋₁+ϵₜ+θ_{1ϵt-1} (1)

Where Xₜ represents an observed value at time t, ϕ₁ is a coefficient corresponding to Xₜ₋₁, ϕ₀ is a constant, ϵₜ is a white noise serial value corresponding to the time t, θ₁ is the coefficient corresponding to ϵₜ₋₁, and ϵₜ₋₁ is a white noise serial value corresponding to the time t−1.

Step 400, determining a final point prediction result corresponding to the risk level time series data based on the point prediction results corresponding to the multiple sub-series data.

Since the risk level time series data is decomposed into multiple sub-series data in the above, the final point prediction result corresponding to the risk level time series data can be determined by the point prediction results corresponding to the sub-series data.

Step 500, determining a prediction residual corresponding to the final point prediction result.

Specifically, the residual corresponding to the final point prediction result is predicted in the present application and thus it is a premise for the section prediction to obtain the prediction residual of the final point prediction result corresponding to the risk level time series data.

Step 600, determining a section prediction result by performing section prediction based on the prediction residual.

Specifically, compared with point prediction, section prediction in the present application can provide more information and quantify the uncertainty of the prediction result. Therefore, for decision makers, section prediction is a better choice. Probability statistics-based methods, commonly including kernel density estimation methods, quantile regression and boostrap methods, are usually adopted for section prediction. The preferred GARCH model in the present application, first proposed by Bollerslev in 1986, is a financial time series model based on the conditional heteroscedasticity of the asset return volatility. Compared with ARIMA model, the GARCH model takes into account the characteristics of volatility aggregation, so it is more suitable for data in which current volatility is related to the past.

According to the method for predicting a safety risk level section of food according to the present application, future food risk can be accurately predicted by the following steps: obtaining risk level time series data of a food whose risk level is to be predicted; decomposing the risk level time series data to obtain multiple sub-series data; performing point prediction on the decomposed sub-series data to obtain a point prediction result of each sub-series; determining a final point prediction result corresponding to the entire risk level time series data based on the point prediction result corresponding to each sub-series data. Then a prediction residual corresponding to the entire risk level time series data is determined, and section prediction can be performed according to the prediction residual, thus more information can be provided for food safety prediction and the uncertainty of the prediction can be quantified.

In the method for predicting safety risk level section of a food according to an embodiment of the present application, the determining a prediction residual corresponding to the final point prediction result specifically includes:

determining a first time point corresponding to the final point prediction result;

obtaining multiple time points prior to the first time point, where time intervals between every two adjacent time points of the multiple time points are the same, and a first time interval between a time point closest to the first time point and the first time point is equal to the time interval;

determining a prediction residual at each of the multiple time points; and

determining a prediction residual at the first time point based on the prediction residuals at the multiple time points as the prediction residual corresponding to the final point prediction result.

Specifically, the residual in mathematical statistics indicates a difference between an actual observed value and an estimated value (fitting value). The estimated value is the point prediction value, and the actual observed value is the food risk level obtained by the actual test at the time point. In the present application, since the residual is predicted using the time series, the method for predicting the residual corresponding to the predicted time point, that is, the final point prediction result, is to assume that there are multiple time points prior to the first time point. Taking 5 time points, i.e., T1, T2, T3, T4, and T5, as an example for illustration and assuming that the prediction residuals corresponding to the first 4 time points (i.e., T1, T2, T3, and T4) are C1, C2, C3, C4, respectively, the residual at the fifth time point (i.e., T5) can be predicted based on the four residuals. The GARCH model can be used for prediction to obtain the residual at the fifth time point, i.e., the residual Y5, which is a predicted value here. Since the fifth time point belongs to the future time relative to the previous 4 time points, the true residual C5 at the fifth time point can be obtained after the true risk level at the fifth time is obtained. Similarly, a residual at next time point is predicted based on C1, C2, C3, C4, C5. Furthermore, the section prediction is performed based on the residual at the next time point.

Moreover, after obtaining the true food safety risk level at the first time point, the true residual at the first time point can be obtained, and the obtained true residual and the true residual at each previous time point can be used to predict a residual at a next time point, and the residual at a next time point is used to perform section prediction and so on, to predict the future food risk level.

In the method for predicting safety risk level section of a food according to the present application, the obtaining risk level time series data of a food whose risk level is to be predicted specifically includes:

obtaining test items of time series of the food and test results corresponding to the test items;

performing numerical processing on non-numerical results among the test results to obtain values of the non-numerical results;

determining a risk level of each sample of the food based on numerical results and the values of the non-numerical results among the test results;

determining a risk level of the food corresponding a time period based on the risk level of each sample of the food detected during the time period; and

obtaining the risk level time series data of the food based on the risk level of the food corresponding to each time period of respective time periods.

Specifically, in the present application, by obtaining the test data of sauce braised meat products for a total of 6 years from 2014 to 2019, 10 regions with the largest amount of data are selected as the research objects. Important fields are described as follows in Table 1:

TABLE 1

| Fields | Values | Descriptions |
|---|---|---|
| regions | strings | regions where sampling is |
| | | carried out |
| sampling time | time strings | sampling date |
| sampling number | characters | ID of a sample |
| test items* | numerical/non-numerical | respective test indicators |
| test results* | strings | results corresponding to test |
| | | items |

The most important fields are test items and test results, which are marked with * in the table.

There are many types of test items, such as lead, cadmium, chromium, and N-dimethylnitrosamine. At the same time, different items have different corresponding test results. For example, the results of some test items can be expressed by specific values while some results are expressed by ranges, such as “less than 1.0 (ug/kg).” Therefore, these data need to be normalized before building a model. In the numerical processing stage, a risk level classification table is designed, the principle of which is similar idea expert scoring. In the classification of risk levels, the standards of industry experts are the most important, and the final predicted risk level is also fed back to industry experts for use. The risk level classification is shown in Table 2 as follows.

TABLE 2

| Levels | Standards | Descriptions |
|---|---|---|
| 1 | 0 MRL > test values 0.1 MRL | the lowest risk |
| 2 | 0.1 MRL > test values 0.3 MRL | lower risk |
| 3 | 0.3 MRL > test values 0.7 MRL | moderate risk |
| 4 | 0.7 MRL > test values 1.0 MRL | higher risk |
| 5 | 1.0 MRL > test value | the highest risk |

Risk levels are classified according to their indicator test values, where MRL means maximum residue limit, and each level boundary is defined based on the opinions of industry experts. The lower test levels 1-2 can be considered as a relatively safe situation, level 3 means that it needs to be paid attention, while levels 4-5 are high-risk levels and means that early warning and preventive measures are required.

In addition, a sample usually has multiple test items, and the risk of this sample needs to be evaluated based on the test results of these test items. Therefore, the sample risk level is designed to describe the sample. Further, an integrated risk level mode is used to express a risk status of a certain area in a certain period of time by comprehensively considering that a prediction target is to evaluate the overall risk of a certain region, in that original data are not sampled at equal time intervals, originate from different regions and are susceptible by other factors besides time. The method for determining the integrated risk level is referred to Table 3:

TABLE 3

| Name | Equation | Description of parameters |
|---|---|---|
| integrated | Level = | wᵢ represents the proportion of data |
| sample level | argmax(wᵢ * eⁱ) | with a level of i in the test items, e |
| | | is a constant |
| integrated time | Level = wᵢ * eⁱ | wᵢi represents the proportion of data |
| period level | | with an integrated sample level i in |
| | | a natural week, e is a constant |

Non-numerical values need to be numerically processed since they are present in test results. The processing method needs to be determined based on the corresponding industry standards.

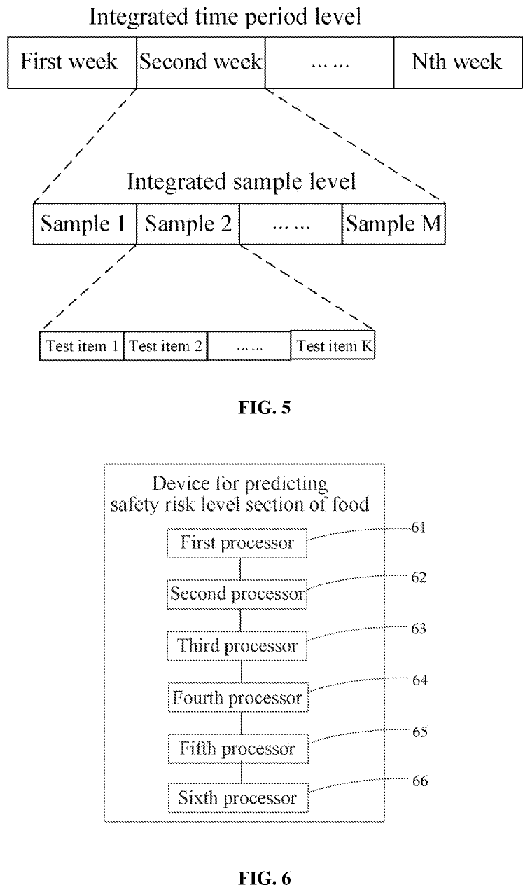

As shown in FIG. 5, there are multiple test items for each sample, and an indicator needs to be used to measure the risk situation of the entire sample. There may be multiple samples taken every week, and an indicator needs to be used to evaluate the risk situation in this week.

In the method for predicting safety risk level section of a food according to the present application, the decomposing food risk level time series data specifically includes:

decomposing the risk level time series data by wavelet packet decomposition.

Specifically, the food risk level time series data is decomposed, for example, using wavelet packet decomposition which is a derivative of wavelet decomposition. Wavelet decomposition will only be used to decompose low-frequency signals recursively instead of decomposing high-frequency signals, while the wavelet packet decomposition is used to decomposes both low-frequency and high-frequency information recursively. Therefore, wavelet packet decomposition is competent to classify the original signal in more detail, and is superior to the wavelet decomposition especially for processing high-frequency signals. The multiple sub-series data can be obtained using wavelet packet decomposition.

In the method for predicting a safety risk level section of food according to the present application, the determining a final point prediction result corresponding to the risk level time series data based on the point prediction results corresponding to the multiple sub-series data specifically includes:

summing the point prediction results corresponding to the multiple sub-series data to obtain a sum as the final point prediction result corresponding to the risk level time series data.

Specifically, due to the decomposition of the risk level time series, when the future food risk level based on the risk level time series is predicted, a value, which is obtained by performing point prediction operation on each sub-series and then summing the predicted values of all points, is used as the final point prediction result corresponding to the entire risk level time series, that is, as a specific predicted value of the risk point level predicted in the future.

In the method for predicting safety risk level section of a food according to the present application, the determining a prediction residual at each of the multiple time points specifically includes:

determining a second point prediction result at each of the multiple time points;

obtaining a risk level actual value at each of the multiple time points; and

determining a prediction residual at each of the multiple time points based on the second point prediction result and the risk level actual value.

Specifically, in the present application, five time points, i.e., T1, T2, T3, T4, and T5, are taken as an example for description. The second point prediction corresponding to each time point is the sum of the previous point predictions. As an illustration, the second point prediction result corresponding to T5 is a sum of the point prediction results corresponding to the previous time points T1, T2, T3, and T4.

The residual in mathematical statistics refers to a difference between an actual observed value and an estimated value (fitting value). The estimated value is the point prediction value, and the actual observation value is the food risk level obtained by the actual test at the time point. Therefore, by obtaining the actual detected food risk level data corresponding to T5, the prediction residual corresponding to T5 can be determined based on the actual value and the second point prediction result.

In the method for predicting safety risk level section of a food according to the present application, when there is a missing risk level in one or more time periods of the various time periods, the missing risk level in one or more time periods can be complemented by an interpolation method.

Specifically, for the possibility of missing weekly data, it needs to be complemented by an interpolation method.

Aiming at the problem of missing weekly data, the commonly used interpolation methods include linear spline interpolation, quadratic spline interpolation and Gaussian process regression. Gaussian process regression is to use the conditional distribution of multidimensional Gaussian process to perform regression prediction. Its formal expression is as follows: training set T=(X, y)=(X₁, y₁), (X₂, y₂), . . . , (Xₙ, yₙ), where Xᵢ is a feature vector and yᵢ is a corresponding label.

For a newly observed feature vector X*, a predicted label given by Gaussian regression is:

y*=k(X*,X)K(X,X)⁻¹y (2)

The interpolation problem is fundamentally a regression problem. The known observation points are used as the training set to build and train the model, and a missing value is used as the value to be predicted. Therefore, Gaussian process regression can be used to complete the interpolation process.

Both linear spline interpolation and quadratic spline interpolation belong to spline interpolation, that is, the defined interval is divided into {(xᵢxᵢ₊₁)li∈[1, k−1]} by interpolation nodes {x₁, x₂, . . . , xₖ}, the corresponding interpolation function fᵢ(x) is used for interpolation in each subinterval (xᵢ, xᵢ₊₁), and a method of undetermined coefficients is used to solve all the coefficient terms of fᵢ(x).

$$f ( x ) = \{ \begin{matrix}{f}_{1} ( x ) & {x}_{1} \leq x < {x}_{2} \\ {f}_{2} ( x ) & {x}_{2} \leq x < {x}_{3} \\ . . . & … \\ {f}_{k - 1} ( x ) & {x}_{k - 1} \leq x < {x}_{k}\end{matrix} \qquad ( 3 )$$

when fᵢ(x)=ax+b, f(x) is linear spline interpolation, and when fᵢ(x)=ax²+bx+c, f(x) is quadratic spline interpolation.

As shown in FIG. 6, a device for predicting a safety risk level section of food according to the present application is described, including:

a first processor 61 configured to obtain risk level time series data of a food whose risk level is to be predicted;

a second processor 62 configured to decompose the risk level time series data to obtain multiple sub-series data;

a third processor 63 configured to perform point predictions on the multiple sub-series data to obtain corresponding point prediction results;

a fourth processor 64 configured to determine a final point prediction result corresponding to the risk level time series data based on the point prediction results corresponding to the multiple sub-series data;

a fifth processor 65 configured to determine a prediction residual corresponding to the final point prediction result; and

a sixth processor 66 configured to determine a section prediction result by performing a section prediction based on the prediction residual.

Since the device according to the embodiment of the present application can be used to implement the method described in the foregoing embodiment, it has similar working principles and beneficial effects to the method, so that it will not be described in detail here, and the specific content can be referred to the introduction of the foregoing embodiment.

In the device for predicting safety risk level section of a food according to the present application, future food risk can be accurately predicted by the following steps: obtaining risk level time series data of a food whose risk level is to be predicted; decomposing the risk level time series data to obtain multiple sub-series data; performing point prediction on the decomposed sub-series data to obtain a point prediction result of each sub-series; determining a final point prediction result corresponding to the entire risk level time series data based on the point prediction result corresponding to each sub-series data. More information can be provided for food safety prediction and the uncertainty of the prediction can be quantified by determining a prediction residual corresponding to the entire risk level time series data, and performing section prediction according to the prediction residual.

In the device for predicting safety risk level section of a food according to the embodiment of the present application, the fifth processor 65 is further configured to:

determine a first time point corresponding to the final point prediction result;

obtain multiple time points prior to the first time point, time intervals between every two adjacent time points of the multiple time points are the same, and a first time interval between a time point closest to the first time point and the first time point is equal to the time interval;

determine a prediction residual at each of the multiple time points; and

determine a prediction residual at the first time point based on the prediction residuals at the multiple time points as the prediction residual corresponding to the final point prediction result.

In the device for predicting safety risk level section of a food according to an embodiment of the present application, the first processor 61 is further configured to:

obtain test items of time series of the food and test results corresponding to the test items;

perform numerical processing on non-numerical results among the test results to obtain values of the non-numerical results;

determine a risk level of each sample to be predicted based on the numerical result and the values of the non-numerical results among the test results;

determine a risk level of the food in a time period based on the risk level of each sample of the food detected in a time period; and

obtain the risk level time series data of the food based on the risk level of the food corresponding to each time period of respective time periods.

In the device for predicting safety risk level section of a food according to an embodiment of the present application, the second processor 62 is further configured to:

decompose the risk level time series data by wavelet packet decomposition.

In the device for predicting safety risk level section of a food according to an embodiment of the present application, the fourth processor 64 is further configured to:

sum the point prediction results corresponding to the sub-series data to obtain a sum as the final point prediction result corresponding to the risk level time series data.

In the device for predicting safety risk level section of a food according to an embodiment of the present application, the fifth processor 65 is further configured to:

determine a second point prediction result at each of the multiple time points;

obtain a risk level actual value at each of the multiple time points; and

determine the prediction residual at each of the multiple time points based on the second point prediction result and the risk level actual value.

In the device for predicting safety risk level section of a food according to an embodiment of the present application, the device further includes a seventh processor 61 configured to:

complement the missed risk level in one or more time periods by an interpolation method if there is a missing risk level in one or more time periods of the respective time periods.

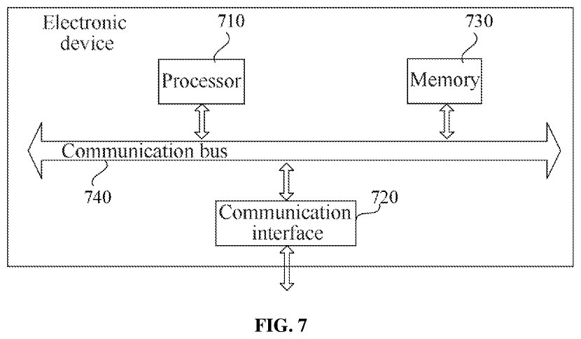

FIG. 7 is a schematic diagram of the physical structure of an electronic device. As shown in FIG. 7, the electronic device may include a processor 710, a communication interface 720, a memory 730, and a communication bus 740. The processor 710, the communication interface 720, and the memory 730 communicate with each other through the communication bus 740. The processor may call the logic instructions in the memory 730 to implement the method for predicting safety risk level section of a food, including: obtaining risk level time series data of a food whose risk level is to be predicted; decomposing the risk level time series data to obtain multiple sub-series data; performing point predictions on the multiple sub-series data to obtain corresponding point prediction results; determining a final point prediction result corresponding to the risk level time series data based on the point prediction results corresponding to the multiple sub-series data; determining a prediction residual corresponding to the final point prediction result; and determining a section prediction result by performing section prediction based on the prediction residual.

In addition, the logic instructions in the memory 730 described above may be implemented in the form of a software functional unit and may be stored in a computer readable storage medium while being sold or used as a separate product. Based on such understanding, the technical solutions of the present application in essence or a part of the technical solutions that contributes to the prior art, or a part of the technical solutions, may be embodied in the form of a software product, which is stored in a storage medium, including several instructions to cause a computer device (which may be a personal computer, server, or network device, etc.) to perform all or part of the steps of the methods described in the respective embodiments of the present application. The storage medium described above includes various media that can store program codes such as U disk, mobile hard disk, read-only memory (ROM), random access memory (RAM), magnetic disk, and compact disk.

In another aspect, a computer program product is further provided in the present application. The computer program product includes computer programs which are stored on a non-transitory computer-readable storage medium and includes program instructions, when the computer programs are executed by a computer, the computer implements the method for predicting safety risk level section of a food, including: obtaining food risk level time series data of a food whose risk level is to be predicted; decomposing the risk level time series data to obtain multiple sub-series data; performing point predictions on the multiple sub-series data to obtain corresponding point prediction results; determining a final point prediction result corresponding to the risk level time series data based on the point prediction results corresponding to the multiple sub-series data; determining a prediction residual corresponding to the final point prediction result; and determining a section prediction result by performing section prediction based on the prediction residual.

In still another aspect, a non-transitory computer-readable storage medium is further provided in the present application, having stored thereon computer programs, when the computer programs are executed by a processor, the processor implements the method for predicting safety risk level section of a food, including: obtaining risk level time series data of a food whose risk level is to be predicted; decomposing the risk level time series data to obtain multiple sub-series data; performing point predictions on the multiple sub-series data to obtain corresponding point prediction results; determining a final point prediction result corresponding to the risk level time series data based on the point prediction results corresponding to the multiple sub-series data; determining a prediction residual corresponding to the final point prediction result; and determining a section prediction result by performing section prediction based on the prediction residual.

The device embodiments described above are merely illustrative, wherein the units described as separate components may or may not be physically separate, and the components displayed as units may or may not be physical units, that is, may be located at the same place or be distributed to multiple network units. Some or all of the modules may be selected according to actual needs to achieve the purpose of the solution of the present embodiment. Those of ordinary skill in the art can understand and implement the embodiments described above without paying creative labors.

Through the description of the embodiments above, those skilled in the art can clearly understand that the various embodiments can be implemented by means of software and a necessary general hardware platform, and of course, by hardware. Based on such understanding, the technical solutions of the present application in essence or a part of the technical solutions that contributes to the prior art, or a part of the technical solutions, may be embodied in the form of a software product, which may be stored in a storage medium such as ROM/RAM, magnetic disk, and compact disk, and includes several instructions to cause a computer device (which may be a personal computer, server, or network device, etc.) to perform the methods described in various embodiments or a part thereof.

Finally, it should be noted that the embodiments above are only used to explain the technical solutions of the present application, and are not limited thereto; although the present application has been described in detail with reference to the foregoing embodiments, it should be understood by those skilled in the art that they can still modify the technical solutions documented in the foregoing embodiments and make equivalent substitutions to a part of the technical features; these modifications and substitutions do not make the essence of the corresponding technical solutions depart from the scope of the technical solutions of various embodiments of the present application.

1. A method for predicting a safety risk level section of food, comprising:
obtaining risk level time series data of the food;
decomposing the risk level time series data to obtain a plurality of sub-series data;
performing point predictions on the plurality of sub-series data to obtain corresponding point prediction results;
determining a final point prediction result corresponding to the risk level time series data based on the point prediction results corresponding to the plurality of sub-series data;
determining a prediction residual corresponding to the final point prediction result; and
determining a section prediction result by performing section prediction based on the prediction residual.

2. The method of claim 1, wherein the determining the prediction residual corresponding to the final point prediction result comprises:
determining a first time point corresponding to the final point prediction result;
obtaining a plurality of time points prior to the first time point, wherein time intervals between every two adjacent time points of the plurality of time points are the same, and a first time interval between a time point closest to the first time point and the first time point is equal to the time interval;
determining a prediction residual at each of the plurality of time points; and
determining a prediction residual at the first time point based on the prediction residuals at the plurality of time points as the prediction residual corresponding to the final point prediction result.

3. The method of claim 1, wherein the obtaining risk level time series data of the food comprises:
obtaining test items of time series of the food and test results corresponding to the test items;
performing numerical processing on non-numerical results among the test results to obtain values of the non-numerical results;
determining a risk level of each sample of the food based on numerical results and the values of the non-numerical results among the test results;
determining a risk level of the food corresponding a time period based on the risk level of each sample of the food detected during the time period; and
obtaining the risk level time series data of the food based on the food risk level of the food corresponding to each time period of respective time periods.

4. The method of claim 1, wherein the decomposing the risk level time series data comprises:
decomposing the risk level time series data by wavelet packet decomposition.

5. The method of claim 1, wherein the determining the final point prediction result corresponding to the risk level time series data based on the point prediction results corresponding to the plurality of sub-series data comprises:
summing the point prediction results corresponding to the plurality of sub-series data to obtain a sum as the final point prediction result corresponding to the risk level time series data.

6. The method of claim 2, wherein the determining the prediction residual at each of the plurality of time points comprises:
determining a second point prediction result at each of the plurality of time points;
obtaining a risk level actual value at each of the plurality of time points; and
determining the prediction residual at each of the plurality of time points based on the second point prediction result and the risk level actual value.

7. The method of claim 3, wherein the missing risk level in one or more time periods is complemented by an interpolation method when there is a missing risk level in one or more time periods of the respective time periods.

8. A device for predicting a safety risk level section of food, comprising:
a first processor configured to obtain risk level time series data of the food;
a second processor configured to decompose the risk level time series data to obtain a plurality of sub-series data;
a third processor configured to perform point predictions on the plurality of sub-series data to obtain corresponding point prediction results;
a fourth processor configured to determine a final point prediction result corresponding to the risk level time series data based on the point prediction results corresponding to the plurality of sub-series data;
a fifth processor configured to determine a prediction residual corresponding to the final point prediction result; and
a sixth processor configured to determine section prediction result by performing a section prediction based on the prediction residual.

9. An electronic device, comprising a memory, a processor, and computer programs stored on the memory and executable on the processor, wherein the processor is configured to implement steps of the method of claim 1 when executing the computer programs.

10. A non-transitory computer-readable storage medium, having computer programs stored thereon, wherein when the computer programs are executed by a processor, the processor implements steps of the method of claim 1.
